(19) United States
(12) Patent Application Publication
(10) Pub. No.: US 2024/0403691 A1
(43) Pub. Date: Dec. 5, 2024

(54) CLASSIFICATION OF TRANSACTIONS

(71) Applicant: FMR LLC, Boston, MA (US)

(72) Inventors: Balaji Rengarajan, Chennai (IN); Shouvik Pradhan, Saginaw, TX (US); Siobhan Byrne, Delgany (IE); Siobhan Cassidy, Dublin (IE)

(21) Appl. No.: 18/203,152

(22) Filed: May 30, 2023

(51) Int. Cl. G06N 20/00; G06N 5/022

(52) U.S. Cl. CPC G06N 20/00; G06N 5/022

(57) ABSTRACT

A computer-implemented method is provided for automatically classifying a selected transaction. The method includes receiving historical data comprising a plurality of historical transactions assigned to respective ones of a plurality of transaction classes and preprocessing historical data, including (i) correlating portions of the historical data to respective ones of the plurality of transaction classes and (ii) cleansing the historical data. The method also includes tokenizing the preprocessed historical data portion and vectorizing the plurality of tokens generated. The method further includes generating a classifier for predicting transaction classes for incoming transaction data and providing data related to the selected transaction to the classifier to generate a prediction of a transaction class for assignment to the selected transaction.

### BACKGROUND

### Technical Field

This application generally relates to systems, methods and apparatuses, including computer program products, for automatically classifying transactions with respect to multiple transaction classes.

### Background Information

Reconciliation is a central process that compares two sets of transactions and ensures that information from one set of transactions (e.g., sales figures from a company's internal system) matches with information from the other set of transactions (e.g., external bank's statements). Currently, reconciliation is performed using centrally maintained rule-based engines to reconcile two sets of transactions. The transactions that are automatically processed in this manner using the rule-based engines are called auto-match and they require no further actions. However, for transactions that are not matched by the current approach, such transactions (hereinafter referred to as “exceptions”) are manually researched by analysts with domain expertise and manually reclassified. In some cases, a sub-set of such exceptions cannot be reclassified and hence are tagged as miscellaneous by default for further research.

Therefore, there is a need for an automated process to enable re-classification of these transaction exceptions.

### SUMMARY

Reconciliation systems as described above generally have a rich body of historical data, including references to previous transaction records and their actual transaction classes after intensive research by analysts. The instant invention relates to identification of hidden patterns in current and historical data (e.g., stored in a company's reconciliation system) for the purpose of performing automated reclassification of a transaction exception. Such automated process reduces manual touch points and increases overall straight-through processing. In some embodiments, a predictive model is constructed using multiclass classification techniques and text analytics to derive features from historical data and enable prediction of transaction class(es) for a transaction of interest. In some embodiments, the historical data is stored a pre-processed library of weighted keywords and their corresponding actual transaction classes.

In one aspect, the present invention features a computer implemented method for automatically classifying a selected transaction. The method includes receiving, by a computing device, historical data comprising a plurality of historical transactions assigned to respective ones of a plurality of transaction classes, and preprocessing, by the computing device, the historical data including (i) correlating portions of the historical data to respective ones of the plurality of transaction classes and (ii) cleansing the historical data. The method also includes tokenizing, by the computing device, the preprocessed historical data portion for each transaction class to generate a plurality of tokens for each transaction class, and vectorizing, by the computing device, the plurality of tokens associated with each transaction class to generate a set of vectorized tokens for each transaction class that comprises a plurality of normalized weights assigned to the tokens based on a frequency of occurrences of the tokens within the corresponding transaction class. The method further includes generating, by the computing device, a classifier for predicting transaction classes for incoming transaction data. Generating the classifier comprises training, by the computing device, a machine learning model for predicting transaction classes, where the machine learning model is trained using the vectorized tokens and their corresponding transaction classes. Generating the classifier also comprises generating, by the computing device, a heuristic layer for predicting transaction classes, where the heuristic layer includes a plurality of predefined prediction rules correlated to respective ones of a plurality of transaction classes. Generating the classifier further comprises combining, by the computing device, the heuristic layer with the machine learning model to generate the classifier. The method additionally includes providing, by the computing device, data related to the selected transaction to the classifier to generate a prediction of a transaction class for assignment to the selected transaction along with a confidence score associated with the predicted transaction class.

In another aspect, the present invention features a computer-implemented system for automatically classifying a selected transaction. The computer-implemented system comprises a computing device having a memory for storing instructions. The instructions, when executed, configure the computer-implemented system to provide a data preparation module configured to preprocess historical data by (i) correlating portions of the historical data to respective ones of the plurality of transaction classes and (ii) cleansing the historical data. The historical data comprises a plurality of historical transactions assigned to respective ones of a plurality of transaction classes. The computer-implemented system also includes a data processing module configured to (i) tokenize the preprocessed historical data portion for each transaction class to generate a plurality of tokens for each transaction class, and (ii) vectorize the plurality of tokens associated with each transaction class to generate a set of vectorized tokens for each transaction class that comprises a plurality of normalized weights assigned to the tokens based on a frequency of occurrences of the tokens within the corresponding transaction class. The computer-implemented system further includes a classifier module configured to predict transaction classes for incoming transaction data. The classifier module is configured to train a machine learning model for predicting transaction classes, where the machine learning model is trained using the vectorized tokens and their corresponding transaction classes. The classifier module is also configured to generate a heuristic layer for predicting transaction classes, where the heuristic layer comprises a plurality of predefined prediction rules correlated to respective ones of a plurality of transaction classes. The classifier module is further configured to combine the heuristic layer with the machine learning model to generate the classifier. The classifier module is configured to generate a transaction class prediction for the selected transaction along with a confidence score associated with the predicted transaction class based on data related to the selected transaction.

Any of the above aspects can include one or more of the following features. In some embodiments, the historical data is in an unstructured text form. In some embodiments, cleansing the historical data comprises removing non-contextual data from the historical data, including removing at least one of symbols, predefined characters or numbers from the historical data.

In some embodiments, tokenizing the preprocessed historical data comprises applying a unigram methodology that transforms each token into an independent feature. In some embodiments, vectorizing the plurality of tokens is performed using at least one of a term frequency-inverse document frequency (TF-IDF) vectorization approach or a count vectorization approach.

In some embodiments, a SelectKBest algorithm is applied to optimally reduce a number of the plurality of tokens in each transaction class. IN some embodiments, the machine learning model is periodically re-trained with new historical data.

In some embodiments, providing data related to the selected transaction to the classifier to generate the predicted transaction class for the selected transaction includes first providing the data to the heuristic layer to determine if a predefined prediction rule is satisfied. If a predefined prediction rule is satisfied, the corresponding transaction class is selected as the predicted transaction class for the selected transaction. If no prediction rule in the heuristic layer is satisfied, the data is provided to the machine learning model to determine the predicted transaction class for the selected transaction.

In some embodiments, the selected transaction represents an exception from a manual classification procedure. The historical data can include reclassifications of the historical exceptions.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows an exemplary diagram of an automated classification system, according to some embodiments of the present invention.

FIG. 2 shows an exemplary process utilized by the classification system of FIG. 1 to automatically predict transaction class for a transaction of interest, according to some embodiments of the present invention.

FIG. 3 shows an exemplary process implemented by the classification system to predict a transaction class for assignment to a transaction of interest using the classifier developed using the process of FIG. 2, according to some embodiments of the present invention.

FIG. 4 shows data for an exemplary list of transactions input to the classification system of FIG. 1 for determining class predictions, according to some embodiments of the present invention.

### DETAILED DESCRIPTION

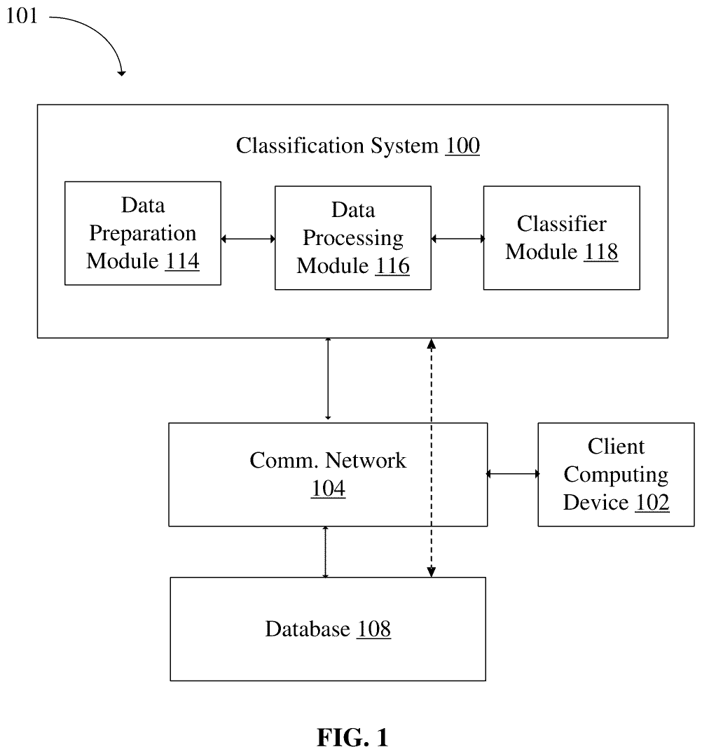

FIG. 1 shows an exemplary diagram of an automated classification system 100 used in a computing environment 101 for automatically determining transaction classification for a selected transaction, according to some embodiments of the present invention. As shown, computing environment 101 generally includes at least one client computing device 102, a communication network 104, the classification system 100, and at least one database 108.

The client computing device 102 can be associated with a user who requires classification of a transaction. The client computing device 102 can connect to the communication network 104 to communicate with the classification system 100 and/or the database 108 to provide inputs and receive outputs for display to the user. For example, the computing device 102 can provide a detailed graphical user interface (GUI) that displays classification prediction for a transaction of interest using the analysis methods and systems described herein. Exemplary computing devices 102 include, but are not limited to, telephones, desktop computers, laptop computers, tablets, mobile devices, smartphones, and internet appliances. It should be appreciated that other types of computing devices that are capable of connecting to the components of the computing system 101 can be used without departing from the scope of invention. Although FIG. 1 depicts a single computing device 102, it should be appreciated that the computing system 101 can include any number of client devices for communication by any number of users.

The communication network 104 enables components of the computing environment 101 to communicate with each other to perform the process of transaction class prediction. The network 104 may be a local network, such as a LAN, or a wide area network, such as the Internet and/or a cellular network. In some embodiments, the network 104 is comprised of several discrete networks and/or sub-networks (e.g., cellular to Internet) that enable the components of the system 100 to communicate with each other.

The classification system 100 is a combination of hardware, including one or more processors and one or more physical memory modules and specialized software engines that execute on the processor of the classification system 100, to receive data from other components of the computing environment 101, transmit data to other components of the computing environment 101, and perform functions as described herein. As shown, the classification system 100 executes a data preparation module 114, a data processing module 116, and a classifier module 118. These sub-components and their functionalities are described below in detail. In some embodiments, the various components of the classification system 100 are specialized sets of computer software instructions programmed onto a dedicated processor in the classification system 100 and can include specifically designated memory locations and/or registers for executing the specialized computer software instructions.

The database 108 is a computing device (or in some embodiments, a set of computing devices) that is coupled to and in communication with the classification 100 and is configured to provide, receive and store various types of data received and/or created for predicting transaction classes. In some embodiments, all or a portion of the database 108 is integrated with the classification system 100 or located on a separate computing device or devices. For example, the database 108 can comprise one or more databases, such as MySQL™ available from Oracle Corp. of Redwood City, California.

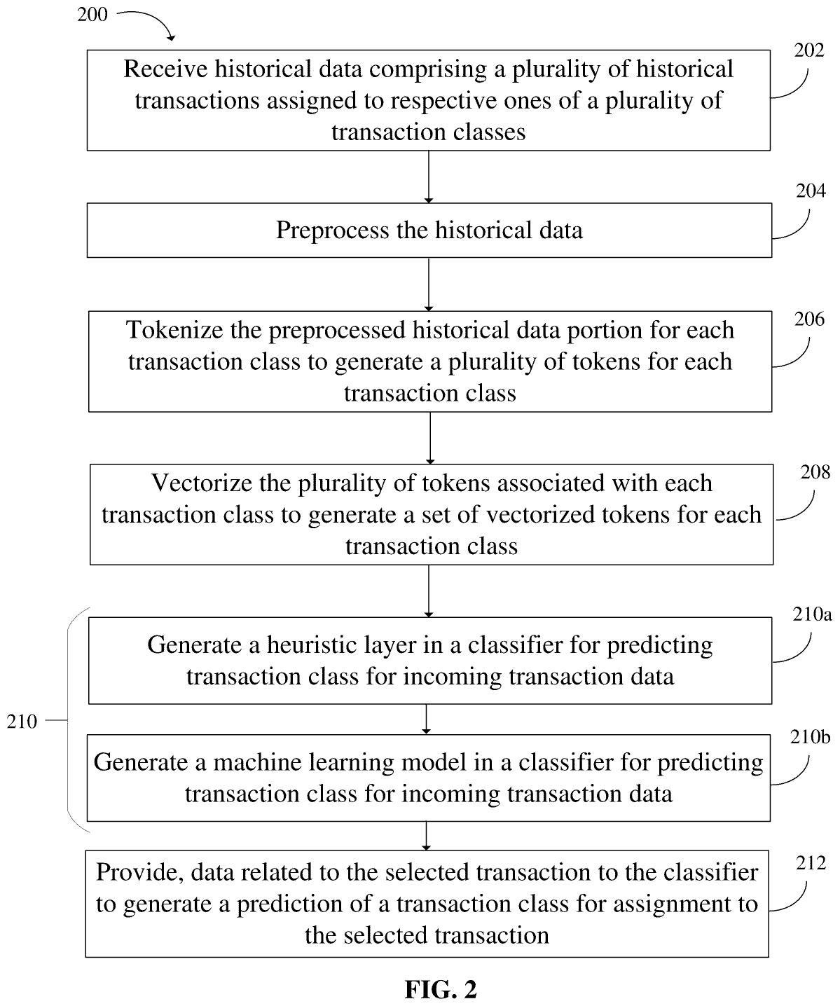

FIG. 2 shows an exemplary process 200 utilized by the classification system 100 of FIG. 1 to automatically predict transaction class for a transaction of interest, according to some embodiments of the present invention. The process 200 starts at step 202 with the classification system 100 receiving and maintaining access to a library of historical data related to multiple historical transactions that have been correctly assigned to respective ones of a list of transaction classes (step 202). The library of historical data can be stored in database 108. The historical data can represent data for historically reclassified exceptions. Typically, to classify a transaction a set of predefine rules can be applied in an automated manner to try to assign a transaction to at least one transaction class. However, if the transaction cannot be classified in this manner (i.e., is an exception to the rule-based classification approach), such transactions are manually reclassified by a human analyst using his domain expertise. Thus, the historical data in the database 108 can represent data for these historical exceptions that have been reclassified by human experts. The historical data stored in the library can include unstructured text-based description of the historical transactions, where the description includes the transaction class(es) manually assigned to the historical transactions.

At step 204, the data preparation module 114 of the classification system 100 is configured to preprocess the historical data in the library 108. In some embodiments, preprocessing the historical data involves extracting portions of the historical data identifying the historical transactions along with the actual class(es) assigned to each of the historical transaction identified. In some embodiments, preprocessing the historical data involves cleansing the historical data, such as removing any non-contextual words or symbols. The transaction description in its unstructured free form may contain stop words, numerical elements and/or special characters that are non-contextual and hence are removed by the data preparation module 114 as a part of the data preparation step. In addition, the data preparation module 104 can remove words in the transaction descriptions of the historical data that fall into a predefined set of generic words (e.g., ‘america’, ‘US’, ‘jan’, ‘january’ ‘february’, ‘march’, ‘April’, etc.). Further, blank/null text are considered as pure missing values and can be removed from the historical data.

At step 206, the data processing module 116 is configured to tokenize the preprocessed historical data portions (from step 204) to transform them into individual tokens using any known approach, such a unigram tokenization approach. In some embodiments, every word/token represents a feature. In some embodiments, a selectKBest feature optimization algorithm can be applied to the tokens (e.g., with a chi-squared statistic of about 95% confidence) to optimally reduce the number of tokens.

At step 208, the data processing module 116 is further configured to vectorize the tokens in the library (from step 206) corresponding to assigned transaction classes to generate a set of vectorized tokens. In some embodiments, the set of vectorized tokens comprises a set of normalized weights assigned to respective ones of the tokens based on, for example, a frequency of occurrences of the tokens within the corresponding transaction classes. More specifically, the weight for a token can represent a normalized figure derived as the total number of occurrences of that token (e.g., word) divided by the total number of words in the corpus of the transaction class to which the token is assigned. Each vectorized token can map a real number to the token. In some embodiments, at least one of a term frequency-inverse document frequency (TF-IDF) vectorization approach or a count vectorization approach is applied by the data processing module 116 to perform the vectorization. Therefore, the library of historical data is transformed to a library of vectorized tokens (e.g., using a unigram vectorization algorithm) mapped to multiple transaction classes. Conversely, the historical data for each transaction class is represented in an N-dimensional vector space holding a real number for all the tokens. Such vector representations are utilized for prediction and similarity identification, as described in detail below.

At step 210, the classifier module 118 is configured to generate a classifier for predicting transaction class assignment for a transaction of interest. Generating the classifier can include generating a heuristic layer 210a in combination with generating a machine learning model 210b. In some embodiments, the machine learning model is configured to predict transaction classes after being trained by the classifier module 118 using the library of historical data, including the vectorized tokens and the transaction classes to which they are mapped (from step 208). An exemplary machine learning model is, but not limited to, a logistic regression model with One V's All (OVA) approach that is used to derive a best-fit transaction class prediction. In some embodiments, the heuristic layer includes a set of one or more predefined, user-configurable rules for predicting transaction classes, where the rules correlate specific tokens to their corresponding transaction classes. For example, each rule can specify one or more tokens that correlate to a transaction class, such that if the description for a transaction of interest includes these tokens, the transaction is mapped to the corresponding class. In some embodiments, the machine learning model of the classifier can be periodically re-trained to incorporate new historical data, and/or the heuristic layer can be periodically updated to include new/revised rules. In some embodiments, the classifier is configured to apply the heuristic layer before the machine learning model when performing class prediction for a transaction of interest. Alternatively, the classifier can apply the machine learning model prior to the heuristic layer for transaction classification.

At step 212, the classification system 100 provides data related to a transaction of interest to the classifier (from step 210) to predict at least one transaction class for assignment to the transaction of interest. In some embodiments, a confidence score is also generated in association with the predicted transaction class. For example, the classification system 100 would only assign a predicted class to the transaction of interest if the confidence score exceeds a predefined threshold (e.g., 75%). In some embodiments, data for the transaction of interest and its predicted class can be stored in the library of historical data for future prediction usage.

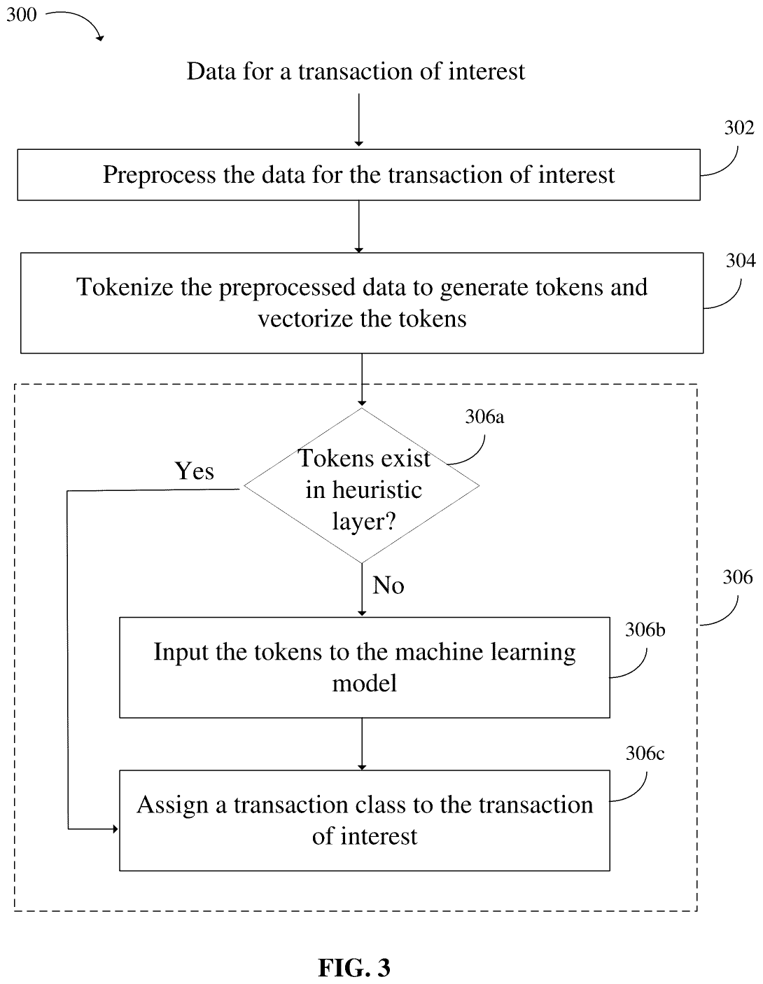

FIG. 3 shows an exemplary process 300 implemented by the classification system 100 of FIG. 1. to predict a transaction class for assignment to a transaction of interest using the classifier developed using the process 200 of FIG. 2, according to some embodiments of the present invention. Descriptive data for the transaction of interest can be supplied to the classification system 100 via the user's computing device 102. In some embodiments, the transaction of interest represents an exception generated by a rule-based classification approach. However, instead of manually reclassifying the exception as what has been done historically, the transaction is reclassified using the automated classifier of the present invention. The data for the transaction of interest entered by a user can include a text-based description of the transaction.

As shown in FIG. 3, after receiving the descriptive data for the transaction of interest, the classification system 100 at step 302 can use the data preparation module 114 to preprocess the transaction data in substantially the same manner described above with respect to step 204 of process 200 FIG. 2. At step 304, the classification system 100 can utilize the data processing module 116 to (i) tokenize the preprocessed data to generate one or more tokens (in substantially the same manner described above with respect to step 206 of process 200) and (ii) vectorize the tokens to generate one or more vectorized tokens (in substantially the same manner described above with respect to step 208 of process 200).

At step 306, the vectorized tokens associated with the transaction of interest is supplied to the classifier (from step 210 of process 200), which includes both a heuristic layer and a machine learning model, to generate a prediction of one or more classes. For example, the vectorized tokens can be first forwarded to the heuristic layer (step 306a) to determine if a predefined prediction rule is satisfied. Satisfaction of a prediction rule can involve checking if the vectorized tokens of the transaction of interest match one or more tokens specified in a rule. If there is a match, the transaction of interest is adapted to be assigned to the transaction class corresponding to the tokens in the rule (step 306c). However, if no prediction rule in the heuristic layer is satisfied, the classification system 100 provides the transaction data to the machine learning model of the classifier (step 306b). The machine learning model is adapted to determine a predicted transaction class for the transaction of interest (step 306c).

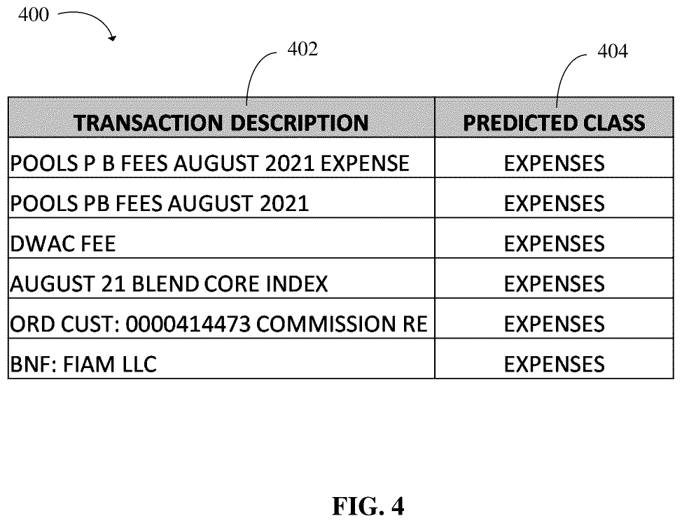

FIG. 4 shows data for an exemplary list of transactions provided to the classification system 100 of FIG. 1 for determining class predictions, according to some embodiments of the present invention. As shown, column 402 of table 400 provides description related to a list of exemplary transactions that require classification. Column 404 provides a list of predicted classes for classifying the corresponding transactions of column 402 using the process 200 described above in FIG. 2.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form. including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

1. A computerized method for automatically classifying a selected transaction, the method comprising:
receiving, by a computing device, historical data comprising a plurality of historical transactions assigned to respective ones of a plurality of transaction classes;
preprocessing, by the computing device, the historical data including (i) correlating portions of the historical data to respective ones of the plurality of transaction classes and (ii) cleansing the historical data;
tokenizing, by the computing device, the preprocessed historical data portion for each transaction class to generate a plurality of tokens for each transaction class;
vectorizing, by the computing device, the plurality of tokens associated with each transaction class to generate a set of vectorized tokens for each transaction class that comprises a plurality of normalized weights assigned to the tokens based on a frequency of occurrences of the tokens within the corresponding transaction class;
generating, by the computing device, a classifier for predicting transaction classes for incoming transaction data, generating the classifier comprising:
training, by the computing device, a machine learning model for predicting transaction classes, the machine learning model being trained using the vectorized tokens and their corresponding transaction classes;
generating, by the computing device, a heuristic layer for predicting transaction classes, the heuristic layer comprising a plurality of predefined prediction rules correlated to respective ones of a plurality of transaction classes; and
combining, by the computing device, the heuristic layer with the machine learning model to generate the classifier; and
providing, by the computing device, data related to the selected transaction to the classifier to generate a prediction of a transaction class for assignment to the selected transaction along with a confidence score associated with the predicted transaction class.

2. The computerized method of claim 1, wherein the historical data is in an unstructured text form.

3. The computerized method of claim 2, wherein cleansing the historical data comprises removing non-contextual data from the historical data, including removing at least one of symbols, predefined characters or numbers from the historical data.

4. The computerized method of claim 1, wherein tokenizing the preprocessed historical data comprises applying a unigram methodology that transforms each token into an independent feature.

5. The computerized method of claim 1, further comprising applying a SelectKBest algorithm to optimally reduce a number of the plurality of tokens in each transaction class.

6. The computerized method of claim 1, wherein vectorizing the plurality of tokens is performed using at least one of a term frequency-inverse document frequency (TF-IDF) vectorization approach or a count vectorization approach.

7. The computerized method of claim 1, further comprising periodically re-train the machine learning model with new historical data.

8. The computerized method of claim 1, wherein providing data related to the selected transaction to the classifier to generate the predicted transaction class for the selected transaction comprises:
first providing the data to the heuristic layer to determine if a predefined prediction rule is satisfied;
if a predefined prediction rule is satisfied, selecting the corresponding transaction class as the predicted transaction class for the selected transaction; and
if no prediction rule in the heuristic layer is satisfied, providing the data to the machine learning model to determine the predicted transaction class for the selected transaction.

9. The computerized method of claim 1, wherein the selected transaction represents an exception from a manual classification procedure.

10. The computerized method of claim 9, wherein the historical data includes reclassifications of the historical exceptions.

11. A computer-implemented system for automatically classifying a selected transaction, the computer-implemented system comprising a computing device having a memory for storing instructions, wherein the instructions, when executed, configure the computer-implemented system to provide:
a data preparation module configured to preprocess historical data by (i) correlating portions of the historical data to respective ones of the plurality of transaction classes and (ii) cleansing the historical data, wherein the historical data comprises a plurality of historical transactions assigned to respective ones of a plurality of transaction classes;
a data processing module configured to (i) tokenize the preprocessed historical data portion for each transaction class to generate a plurality of tokens for each transaction class, and (ii) vectorize the plurality of tokens associated with each transaction class to generate a set of vectorized tokens for each transaction class that comprises a plurality of normalized weights assigned to the tokens based on a frequency of occurrences of the tokens within the corresponding transaction class; and
a classifier module configured to predict transaction classes for incoming transaction data, the classifier module configured to:
train a machine learning model for predicting transaction classes, the machine learning model being trained using the vectorized tokens and their corresponding transaction classes;
generate a heuristic layer for predicting transaction classes, the heuristic layer comprising a plurality of predefined prediction rules correlated to respective ones of a plurality of transaction classes; and
combine the heuristic layer with the machine learning model to generate the classifier,
wherein the classifier module is configured to generate a transaction class prediction for the selected transaction along with a confidence score associated with the predicted transaction class based on data related to the selected transaction.

12. The computer-implemented system of claim 11, wherein the historical data is in an unstructured text form.

13. The computer-implemented system of claim 11, wherein the data preparation modules cleanses the historical data by removing non-contextual data from the historical data, including removing at least one of symbols, predefined characters or numbers from the historical data.

14. The computer-implemented system of claim 11, wherein the data processing module tokenizes the preprocessed historical data by applying a unigram methodology that transforms each token into an independent feature.

15. The computer-implemented system of claim 11, wherein the data processing module is further configured to apply a SelectKBest algorithm to optimally reduce a number of the plurality of tokens in each transaction class.

16. The computer-implemented system of claim 11, wherein the data processing module vectorizes the plurality of tokens by using at least one of a term frequency-inverse document frequency (TF-IDF) vectorization approach or a count vectorization approach.

17. The computer-implemented system of claim 11, wherein the classifier module is further configured to periodically re-train the machine learning model with new historical data.

18. The computer-implemented system of claim 11, wherein the classier module is configured to generate the transaction class prediction for the selected transaction by:
first providing the data to the heuristic layer to determine if a predefined prediction rule is satisfied;
if a predefined prediction rule is satisfied, selecting the corresponding transaction class as the predicted transaction class for the selected transaction; and
if no prediction rule in the heuristic layer is satisfied, providing the data to the machine learning model to determine the predicted transaction class for the selected transaction.

19. The computer-implemented system of claim 11, wherein the selected transaction represents an exception from a manual classification procedure.

20. The computer-implemented system of claim 19, wherein the historical data includes reclassifications of the historical exceptions.
